(19) United States
(12) Patent Application Publication
(10) Pub. No.: US 2009/0255292 A1
(43) Pub. Date: Oct. 15, 2009

(54) Refrigeration Device having a Height-Adjustable Carrier for Refrigerated Goods and a Safety Cut-Off System

(75) Inventor: Thomas Benz, Haar (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Husgerate GmbH, Muenchen (DE)

(21) Appl. No.: 11/991,694

(22) PCT Filed: Aug. 31, 2006
(86) PCT No.: PCT/EP2006/065874

§ 371 Date: Mar. 6, 2008

(30) Foreign Application Priority Data
Sep. 12, 2005 (DE) 10 2005 043 356.1

(51) Int. Cl. F25D 25/00; G05B 15/00

(52) U.S. Cl. 62/378; 62/465; 700/275

(57) ABSTRACT

A refrigeration device includes an interior space enclosed by a heat-insulating housing and a carrier for refrigerated goods that can be vertically displaced inside the interior space by means of a drive device. The refrigeration device includes a force sensor that detects a change in force acting upon the carrier for refrigerated goods in the direction of displacement and a control which is adapted to stop the carrier for refrigerated goods when a change in force is detected.

The present invention relates to a refrigeration device having an interior surrounded by a thermally insulating housing and having a refrigerated product carrier vertically displaceable in the interior by a drive device.

Such a device in the form of a drinks bar is known from DE 199 24 563 A1. The drinks bar comprises a chest-like housing, which is insulated against the incidence of heat and surrounds an interior for receiving bottles and drinking glasses and has an opening closable by means of a lid. The bottles and drinking glasses are suspended from and/or deposited on refrigerated product carriers. The refrigerated product carriers are vertically displaceable by means of lifting gear, for example a gas pressure spring, up to a level in the region of the upper opening in order to come within reach of persons to be supplied. If the refrigerated product carriers after the removal of glasses and drinks are moved back into the interior via the upper opening, there is a risk that articles, which are deposited on the edge of the counter surrounding the upper opening and project into the opening, may be caught and damaged by the downward traveling refrigerated product carriers. There is moreover a risk that during downward travel persons being supplied may in particular trap and injure their fingers between the uppermost refrigerated product carrier, which acts as a lid closing the interior, and the edge of the upper opening of the drinks bar.

The object of the present invention is to indicate a refrigeration device of the type described in the introduction that reliably avoids injury to the user and damage to articles situated in the range of displacement of the refrigerated product carrier.

The object is achieved by a refrigeration device as claimed in claim 1 and by an operating method as claimed in claim 21. The dependent claims refer to preferred embodiments.

A refrigeration device having an interior surrounded by a thermally insulating housing and having a refrigerated product carrier vertically displaceable in the interior by a drive device is accordingly provided. According to the invention, there are provided a force sensor, which detects a variation of the force acting in displacement direction upon the refrigerated product carrier, and a control device, which on detection of such a force variation is devised to bring the refrigerated product carrier to a halt. If the refrigerated product carrier or a refrigerated product deposited on the refrigerated product carrier comes into contact with a stationary obstacle situated in the displacement path of the refrigerated product carrier, a force acts upon the refrigerated product carrier and is detected with the aid of the force sensor. By immediately bringing the refrigerated product carrier to a halt, damage to the refrigerated product or the obstacle is avoided. Hands or fingers of the user that may pass between deposited refrigerated products and refrigerated product carriers and/or inner walls of the refrigeration device are therefore also effectively protected against injury.

The refrigerated product carrier is preferably coupled to the drive device by a lifting element that is vertically displaceable with the drive device. It is therefore possible to install the drive device with the lifting element into the refrigeration device as a preassembled unit that is independent of the refrigerated product carrier.

In the refrigeration device according to the invention, the refrigerated product carrier is preferably mounted in a vertically movable manner on the lifting element by means of a spring element. The advantage of this is that, if the refrigerated product carrier and/or a refrigerated product deposited thereon encounters an obstacle, the refrigerated product carrier yields and so the entire force of, for example, an electric motor used to drive the refrigerated product carrier does not act immediately upon the obstacle. Thus, pinching of trapped fingers or overturning and/or damage of refrigerated products, refrigerated product carriers and interior walls of the refrigeration device is avoided.

The spring element is preferably compressed by the weight of the refrigerated product carrier. Thus, the spring element acts as a compression spring, thereby allowing a simple and cost-effective construction because the compression spring may be disposed in an unconnected manner between the refrigerated product carrier and the lifting element.

The vertical mobility of the refrigerated product carrier relative to the lifting element may be realized for example by mounting the refrigerated product carrier on the lifting element by means of a rail guide. The rail guide is preferably formed by a vertical pin that engages into at least one guide bush, which is situated preferably on the lifting element. This is therefore a simple and cost-effective variant. Also possible however is a rail guide by means of, for example, one or more guide grooves in one component, into which corresponding extensions of the other component engage.

The spring element preferably comprises a spiral spring that surrounds the pin. The spring element is therefore fixed in position by means of the pin, thereby allowing easy assembly.

In the refrigeration device according to the invention, the force sensor preferably comprises the spring element, by means of which the refrigerated product carrier is mounted in a vertically movable manner on the lifting element, and a position sensor, which detects a vertical movement of the refrigerated product carrier relative to the lifting element. The movement of the refrigerated product carrier relative to the lifting element that is detected by the position sensor on account of a compression or relief of the spring element is in this case an indirect measure of the action of a vertical force upon the refrigerated product carrier. The position sensor preferably comprises an inexpensively available potentiometer.

Alternatively, the force sensor may comprise one or more piezoelectric elements. A piezoelectric element under the action of a mechanical load produces a pulse-like voltage signal. It therefore directly indicates a variation of the force acting upon it.

The lifting element is preferably in threaded engagement with at least one vertical threaded spindle, which is set in rotation by a motor. In the refrigeration device according to the invention, the lifting element preferably takes the form of a slide that is guided on a vertical rail.

At least one limit shutdown switch, which is actuable by means of the lifting element or the refrigerated product carrier, is preferably disposed on the rail in order to prevent vertical displacement also of the unloaded refrigerated product carrier beyond a minimum vertical position or a maximum vertical position. Preferably, two limit shutdown switches are provided, which limit the freedom of movement of the refrigerated product carrier both in an upward direction and in a downward direction.

The refrigerated product carrier is preferably detachably connected to the lifting element. This allows the user to remove the refrigerated product carrier from the interior of the refrigeration device for the purpose of cleaning or exchange or if it is not needed for a while.

In the refrigeration device according to the invention, the refrigerated product carrier is preferably detachably fastened to a mounting, which is mounted in a vertically movable manner on the lifting element. This allows the rail guide, which is needed for vertical mobility, to be disposed between the mounting and the lifting element and not directly between the refrigerated product carrier and the lifting element. The refrigerated product carrier therefore need not comprise rail guide means and may be of a simple design. Furthermore; the user, when installing the refrigerated product carrier, does not have to introduce it into a rail guide, thereby facilitating installation. The refrigerated product carrier is preferably connected to the mounting by a releasable detent or plug-in connection, thereby allowing easy installation and removal of the refrigerated product carrier by the user without tools.

The mounting preferably takes the form of a bow having two angular portions, the angular portions bearing the pin. The pin preferably projects with one end beyond the mounting and the refrigerated product carrier is mounted onto this end of the pin. Thus, the pin, by which the mounting and hence the refrigerated product carrier are guided in a vertically displaceable manner on the lifting element, may simultaneously serve as part of a plug-in connection between the refrigerated product carrier and the mounting.

In the case of the force sensor, which comprises the spring element and the position sensor, the control device of the refrigeration device according to the invention is preferably devised so that prior to start-up of the refrigerated product carrier and/or of the lifting element it activates the position sensor and stores the measured value thereof as a reference signal, during displacement of the refrigerated product carrier and/or of the lifting element it compares the measured value of the position sensor with the reference value, and upon exceeding of a limit value of the difference of both values it brings the refrigerated product carrier and/or the lifting element to a halt.

According to the present invention, a method of operating a previously described refrigeration device is also provided, in which after detection of a variation of the force acting in direction of motion upon the refrigerated product carrier the refrigerated product carrier and/or the lifting element are brought to a halt. Preferably, upon exceeding of a limit value of the force variation the refrigerated product carrier and/or the lifting element are brought to a halt.

In the case of the force sensor, which comprises the spring element and the position sensor, the operating method according to the invention preferably comprises the following steps: (a) store the measured value of the position sensor prior to start-up of the refrigerated product carrier and/or lifting element, (b) compare the measured value of the force sensor with the stored reference value during displacement of the refrigerated product carrier and/or lifting element and (c) bring the refrigerated product carrier to a halt upon exceeding of a limit value of the difference of both values.

Preferably, the refrigerated product carrier and/or the lifting element after being brought to a halt are displaced in the reverse direction of travel. Articles and/or fingers of the user that are already trapped may therefore be released immediately without the user for example having to re-actuate a switch used to actuate the displacement of the refrigerated product carrier.

The refrigeration device according to the invention is preferably a domestic refrigerator.

Further features and advantages of the invention arise from the following description of exemplary embodiments with reference to the accompanying figures. These show:

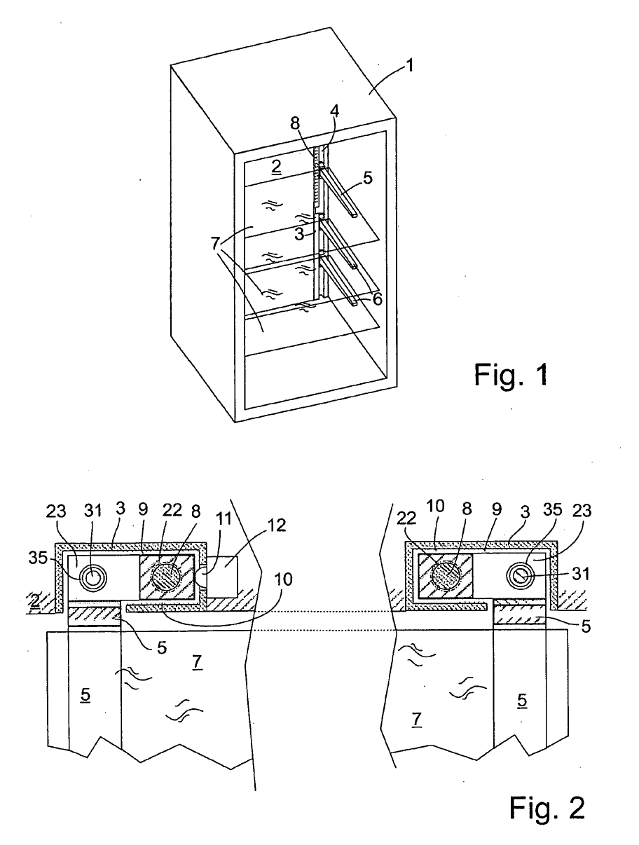

FIG. 1 a diagrammatic perspective view of the carcass 1 of a refrigeration device according to the invention having a refrigerated product carrier 5, 7 that is vertically displaceable by means of a motor 16;

FIG. 2 a horizontal partial section through the carcass 1 along a first horizontal plane;

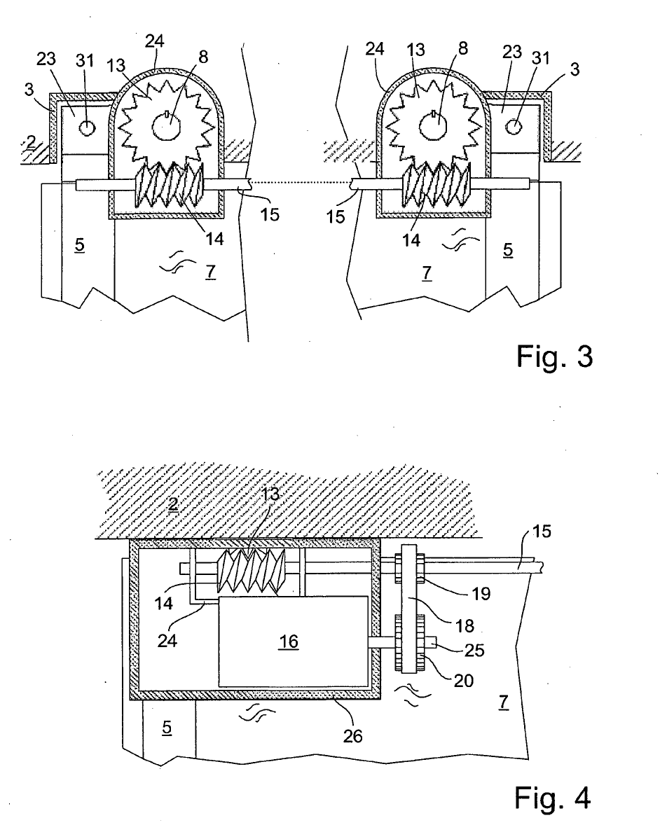

FIG. 3 a partial section through the carcass 1 and of a worm gear 13, 14, which drives the refrigerated product carrier, along a second horizontal plane;

FIG. 4 a horizontal partial section through the carcass 1 at the level of the motor 16 that drives the refrigerated product carrier 5, 7;

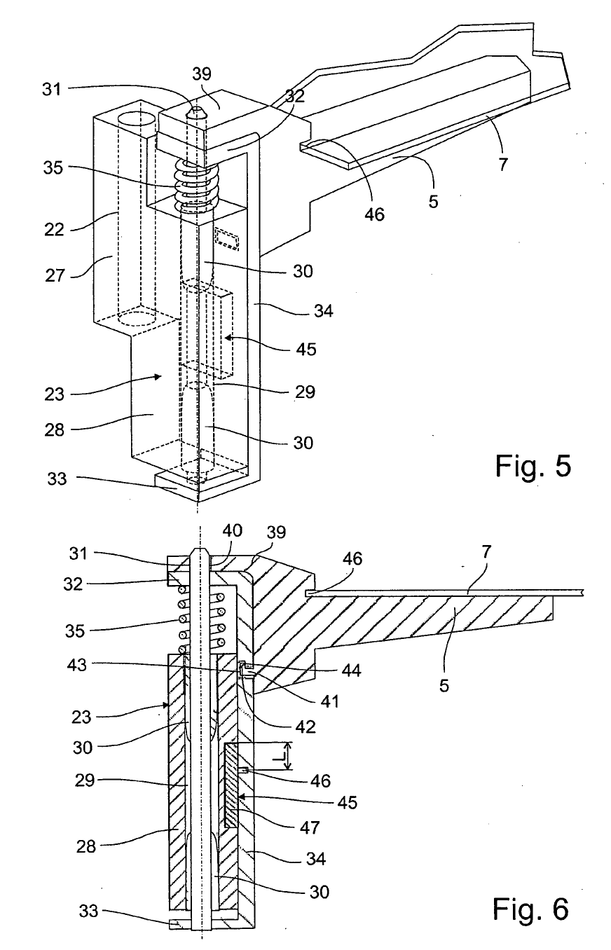

FIG. 5 a perspective view of a bracket 5 of the refrigerated product carrier 5, 7 that is mounted on a vertically displaceable slide 23;

FIG. 6 a vertical section through the arrangement of FIG. 5;

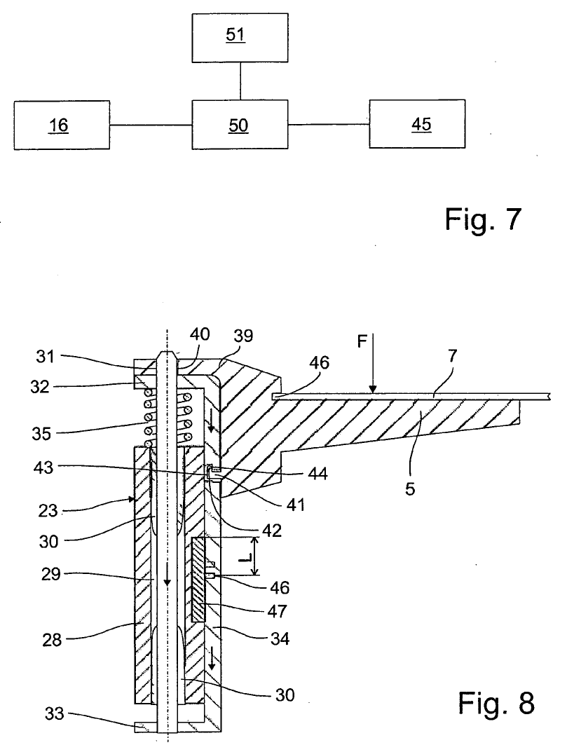

FIG. 7 a control system diagram;

FIG. 8 a section as in FIG. 6 upon loading of the refrigerated product carrier 5, 7 with a force F;

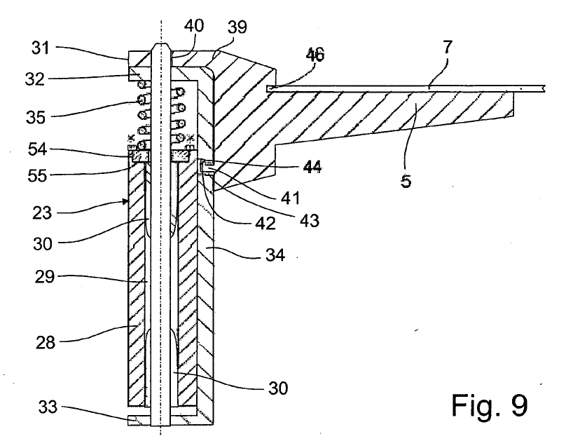

FIG. 9 a vertical section as in FIG. 6 according to a second embodiment of the present invention.

FIG. 1 shows in a perspective view a carcass 1 of a refrigeration device according to the present invention. A door hinge-connected to the open front side of the carcass 1 is omitted from the figure. At the right-hand edge of the back wall 2 a vertical rail 3 let into the back wall 2 may be seen, which has an entry slot 4 open in the direction of the interior, into which a plurality of brackets 5, 6 engage. A corresponding rail 3 with brackets 5, 6 is let in at the left-hand edge of the back wall 2 and hidden in the figure by a side wall of the carcass 1. Each pair of brackets 5, 6 of identical height carries a shelf 7, on which refrigerated products may be deposited for storage in the interior of the refrigeration device. The shelves 7 represented in the figure are transparent and may be realized for example in the form of panes of safety glass. The bottom brackets 6 rest in each case on detent steps that are concealed in the interior of the rails 3.

FIG. 2 shows a partial section through the back wall 2 of the carcass 1 and of the brackets 5 above the shelf 7. As may be seen in this section, the rails 3 each have an undercut guide groove 9, there being disposed in the undercut 10 of the guide groove 9 a vertically extending threaded spindle 8. The threaded spindle 8 is in engagement with an internal thread 22, which is formed on a lifting element 23 guided in the guide groove 9. As is shown in detail in the perspective FIG. 5, the bracket 5 is suspended on this lifting element 23 in the form of slide 23, more details of this being provided later. The thread lead of the spindle 8 is low in order to prevent the spindle 8 being set in rotation as a result of being loaded by the weight of the slide 22, the bracket 5, the shelf 7 and the load carried by the shelf.

FIG. 3 shows a partial section as in FIG. 2 in a higher plane, underneath the top of the carcass 1. Here, there is disposed in a rotationally fixed manner on the top end of each of the threaded spindles 8 a toothed wheel 13, which meshes with a worm 14. The two worms 14 are carried by a common shaft 15, by which the spindles 8 are rotationally coupled to one another, thereby guaranteeing that the two brackets 5 execute always identical vertical displacements. The toothed wheels 13 and the worms 14 are protected from external influences by each being accommodated in a housing 24.

FIG. 4 shows a horizontal partial section in a—compared to FIG. 3—higher plane, adjacent to the top of the carcass 1. In this partial section only the left-hand part of the arrangement shown in FIG. 3 is represented. As may be seen from FIG. 4, the common shaft 15 of the worms 14 is coupled to an electric motor 16 by a toothed belt 18, which revolves on a pinion 19, which is mounted on the shaft 15, and a pinion 20 on an output shaft 25 of the motor 16. This embodiment allows the shaft 15 to extend closely adjacent to the back wall 2 of the carcass without a niche for the electric motor 16 having to be provided in the back wall 2. The electric motor 16 is disposed in a housing 26, which is adjoined in a downward direction by the housing 24 for the left-hand worm 14 and the left-hand toothed wheel 13.

The electric motor 16 may be switched on and off and controlled in terms of its direction of rotation by means of a rocker switch (not shown). Connected in series to this switch are two limit switches, one of which is shown in FIG. 2 and denoted by the reference numeral 12. As is shown in FIG. 2, in a side wall of the left-hand rail 3 an opening is formed, through which a button 11 of the limit switch 12 fitted on the outside of the rail 3 engages into the guide groove 9. The slide 23, when it reaches the button 11, presses it out of the guide groove 9. As a result of actuation of the button 11 the power supply to the electric motor 16 is interrupted, thereby bringing the slide 23 and hence the bracket 5 to a halt. A displacement movement of the brackets 5 is therefore discontinued as soon as the slide 23 reaches an upper or lower limit of its permissible range of displacement, this limit being marked by the limit switch 12. The refrigeration device described in the present figures comprises two such limit switches, which limit the freedom of movement of the slides 23 and hence of the brackets 5 both in an upward direction and in a downward direction.

FIGS. 5 and 6 show the slide 23 and the bracket 5 of the left-hand part of the arrangement represented in the sectional view of FIG. 2. FIG. 5 shows a perspective view, while FIG. 6 shows a longitudinal section through the arrangement along a vertical plane. As is evident from FIG. 5, the slide 23 has a stepped shape comprising a first cuboidal slide part 27, which, as FIG. 2 shows, is disposed inside the undercut 10 of the guide groove 9 and comprises the internal thread 22 that is in mesh with the external thread of the threaded spindle 9. A second cuboidal slide part 28 that is formed integrally with the first slide part 27 is of a downwardly stepped design relative to the first slide part 27. It comprises a vertically extending through-bore 29, into which are introduced two guide bushes 30 that guide a pin 31 in a vertically displaceable manner. The pin 31 is mounted in an axially fixed manner in a mounting 34, to which the bracket 5 is detachably fastened. The mounting 34 takes the form of a bow 34 having two angular portions 32, 33, between which the pin 31 is clamped in an axially fixed manner. Disposed between the upper angular portion 32 of the bow 34 and the second slide part 28 is a spiral spring 35, which surrounds the pin 31. Thus, the bow 34 and hence the bracket 5 rests in a vertically movable and resilient manner on the slide 23.

The bracket 5 comprises an angular portion 39, which is of a complementary design to the bow 34 and rests flat against the bow 34. By means of a through-hole 40 the bracket 5 is mounted detachably onto the pin 31 projecting from the angular portion 32 of the bow 34. The bracket 5 is moreover fastened to the bow 34 by detent means. These comprise a detent arm 41, which is formed on the bracket 5 and has a detent lug 42 that engages into a cutout 43 of the bow 34, the detent lug 42 in the latched state engaging behind an undercut 44 in the bow 34.

As may be seen from FIG. 6, the shelf 7 rests on the bracket 5 and engages into a groove 46 formed in the bracket 6. By virtue of the weight of the bracket 5, the shelf 7 and refrigerated products deposited thereon but not shown in the figures, the spiral spring 35 is compressed.

The arrangement shown in FIGS. 5 and 6 further comprises a position sensor 45 that detects a vertical movement of the bow 34 relative to the slide 23. In the present exemplary embodiment, the position sensor 45 comprises a potentiometer 45. By means of a consumer 46 situated on the bow 45 the vertically extending resistor 47 disposed on the slide 32 is contacted. Depending on the tapped resistor length L, different measured values of the position sensor 45 arise. If, as represented in FIG. 8, a force F acts in vertical direction from above upon the shelf 7, the spiral spring 35 is compressed still further relative to the position represented in FIGS. 5 and 6, with the result that the bow 34 with the consumer 46 and the pin 31 move downwards relative to the slide 23. The previous position of the consumer 46 relative to the resistor 47 is represented in FIG. 8 in a discontinuous line. Thus, a—compared to FIG. 6—greater resistor length L is tapped, with the result that the measured value of the position sensor 45 in FIG. 8 varies relative to that in FIG. 6. The spiral spring 35 and the position sensor 45 therefore act as a force sensor that detects the force acting in vertical direction, i.e. displacement direction of the shelf 7, upon the shelf 7 and/or the brackets 5.

The refrigeration device according to the present embodiment further comprises a control device 50, which is indicated in a block diagram shown in FIG. 7 and which is connected to the electric motor 16, to the position sensor 45 and to the rocker switch denoted by the reference numeral 51, by means of which the user may displace the shelf 7 vertically within the interior of the refrigeration device.

Upon actuation of the rocker switch 51, the control device 50 first activates the position sensor 45, scans the instantaneous measured value thereof and stores it as a reference value in a memory. Then the control device 50 activates the electric motor 16 and arranges for it to be supplied with current and for the shelf 7 to be displaced upwards or downwards depending on the selected rocker position of the switch 51 that determines the direction of rotation of the electric motor 16. During the displacement of the shelf 7, the control device 50 activates the position sensor 45 at predetermined time intervals, scans the instantaneous measured value thereof and compares it to the stored reference value. If the shelf 7 and/or the bracket 5, for example with a refrigerated product deposited thereon, comes into contact with the top of the interior of the refrigeration device, then, as represented in FIG. 8, a force F acts in displacement direction of the shelf 7 upon the shelf 7. As a result of the force acting upon the shelf 7 or the bracket 5 during upward travel the spiral spring 35 is compressed, if the force is acting from above, or relieved, if the force is acting from below, and so the measured value of the position sensor 45 varies. If the amount of the difference between the reference value and the instantaneous measured value exceeds a specific limit value, the control device 50 activates the electric motor 16 and interrupts the power supply to the electric motor 16, with the result that the shelf 7 comes to a halt. In this way, the trapping and damage of refrigerated products or the trapping and injury of fingers of the user may be reliably avoided. It may additionally be provided that the control device 50 subsequently activates the electric motor 16 in order to bring about return travel of the slide 23 in the reverse direction of travel, for example by a specific distance or until the measured resistor value once more corresponds to the reference value.

FIG. 9 shows a second embodiment of the present invention, in which in a recess 54 of the top of the second slide part 28 an annular piezoelectric element 55 is disposed, which surrounds the pin 31. The spiral spring 35 is supported on the piezoelectric element 55. If the piezoelectric element 55, which as a rule comprises a crystalline material, is deformed by a mechanical force, then at the boundary layers of the crystal both the positive and the negative charges shift, thereby resulting in an electric dipole moment. As a result of the ensuing spontaneous polarization a voltage pulse is produced. Each variation of the force exerted by the spiral spring 35 on the piezoelectric element leads to the production of such a voltage pulse in the piezoelectric element 55. As the bracket 5 and the supporting plate 7 are supported on the spiral spring 35, each variation of the vertical force acting upon the supporting plate 7 and/or the brackets 5 in the direction of displacement of the supporting plate 5 may be detected by the piezoelectric element 55.

The refrigeration device according to the second embodiment likewise comprises a control device 50 that is connected to the rocker switch 51, to the electric motor 16 and, in this case, to the piezoelectric element 55. The position sensor 45 shown in FIG. 7 is to be replaced in the second embodiment by the piezoelectric element 55. When the user by switching the rocker switch 51 sets the supporting plate 7 in motion, the control device 50 activates the piezoelectric element 55. If during the displacement of the supporting plate 7 the piezoelectric element 55, because of a variation of the force acting upon it, supplies a voltage pulse, then the control device 50 by activating the electric motor 16 produces the effect that the supporting plate 7 is brought to a halt and optionally moved in reverse. The second embodiment dispenses with the storage of a reference value because the piezoelectric element 55 supplies a voltage pulse as an output signal only upon a variation of the force exerted by the spiral spring 35 on the piezoelectric element 55.

1-24. (canceled)

25. A refrigeration device comprising:
a thermally insulated housing defining an interior and having a refrigerated product carrier vertically moveably mounted in the interior;
a drive device for vertically moving the refrigerated product carrier;
a force sensor for sensing a variation in a force acting upon the refrigerated product carrier in a movement direction; and
a control device in operational communication with the sensor and the drive device for stopping movement of the refrigerated product carrier when the sensor senses a force variation acting upon the refrigerated product carrier in a movement direction.

26. The refrigeration device according to claim 25 wherein the refrigerated product carrier is coupled to the drive device by a lifting element that is vertically moveable by operation of the drive device.

27. The refrigeration device according to claim 26 wherein the refrigerated product carrier is mounted in a vertically movable manner on the lifting element using a spring element and the spring element is biased by the weight of the refrigerated product carrier.

28. The refrigeration device according to claim 26 wherein the refrigerated product carrier is mounted on the lifting element using a rail guide with the rail guide being formed by a vertical pin that engages at least one guide bushing, the guide bushing being disposed on the lifting element, and the refrigerated product carrier being mounted in a vertically movable manner on the lifting element using a spring element with the spring element including a spiral spring that surrounds the pin.

29. The refrigeration device according to claim 27 wherein the force sensor includes the spring element which is used to mount the refrigerated product carrier on the lifting element in a vertically moveable manner, and a position sensor for sensing a vertical movement of the refrigerated product carrier relative to the lifting element.

30. The refrigeration device according to claim 29 wherein the position sensor includes a potentiometer.

31. The refrigeration device according to claim 25 wherein the force sensor includes at least one piezoelectric element.

32. The refrigeration device according to claim 26 wherein the lifting element is in threaded engagement with at least one vertical threaded spindle with the spindle being rotatable by the drive device.

33. The refrigeration device according to claim 26 wherein the lifting element is configured as a slide that is guided on a vertical rail.

34. The refrigeration device according to claim 33 wherein at least one limit shutdown switch is disposed on the rail, with the switch being actuable using of one of the lifting element and the refrigerated product carrier.

35. The refrigeration device according to claim 26 wherein the refrigerated product carrier is detachably connected to the lifting element.

36. The refrigeration device according to claim 26 wherein the refrigerated product carrier is detachably fastened to a mounting element, with the mounting element being mounted in a vertically movable manner on the lifting element.

37. The refrigeration device according to claim 36 wherein the refrigerated product carrier is connected to the mounting element using one of a releasable detent and a plug-in connection.

38. The refrigeration device according to claim 37 wherein the mounting element is configured as a bow with two angular portions with the angular portions bearing the pin.

39. The refrigeration device according to claim 38 wherein a distal end of the pin projects beyond the mounting element and the refrigerated product carrier is mounted onto the distal end of the pin.

40. The refrigeration device according to claim 25 wherein the control device is operable to activate the position sensor prior to driven movement of the refrigerated product carrier to sense the initial position of the refrigerated product carrier and store the sensed value thereof as a reference, compare a sensed instantaneous value of the position sensor with the reference value during movement of the refrigerated product carrier and stop movement of the refrigerated product carrier when the amount of the difference between the reference value and the sensed instantaneous value exceeds a specific limit value.

41. The refrigeration device according to claim 25 wherein the control device is in operative operable to stop movement of the refrigerated product carrier upon the force sensor sensing of a variation of the force acting in the direction of motion of the refrigerated product carrier.

42. The refrigeration device according to claim 41 wherein the control device is in operative operable to stop movement of the refrigerated product carrier upon a determination that the force variation exceeds a limit value of the force variation.

43. The refrigeration device according to claim 42 wherein the control device is operable to store a sensed instantaneous value of the position sensor prior to start-up of the refrigerated product carrier, compare the measured value of the force sensor with the stored reference value during displacement of the refrigerated product carrier and stop movement of the refrigerated product carrier upon exceeding a limit value of the difference of both values.

44. The refrigeration device according to claim 42 wherein the control device is operable to move the refrigerated product carrier in a reverse direction of travel after the refrigerated product carrier has been stopped.
